(19) United States
(12) Patent Application Publication
(10) Pub. No.: US 2020/0043067 A1
(43) Pub. Date: Feb. 6, 2020

(54) RESOURCE TRANSMISSION METHODS AND APPARATUS

(71) Applicant: Alibaba Group Holding Limited, George Town (KY)

(72) Inventor: Xiaodong Gou, Hangzhou (CN)

(73) Assignee: Alibaba Group Holding Limited, George Town (KY)

(21) Appl. No.: 16/598,586

(22) Filed: Oct. 10, 2019

Related U.S. Application Data
(63) Continuation of application No. PCT/CN2018/082766, filed on Apr. 12, 2018.

(30) Foreign Application Priority Data
Apr. 14, 2017 (CN) 201710242797.X

(51) Int. Cl. G06Q 30/06

(52) U.S. Cl. CPC G06Q 30/0609; H04W 12/002; G06Q 30/0619

(57) ABSTRACT

Examples of resource transmission methods and apparatus are described. One example of the methods includes that a server receives a resource sending request of a first user. The resource sending request includes at least a resource to be sent, a user question matching the resource, and location information corresponding to the resource. The server releases the location information to verify a second user based on the user question when the second user obtains the resource through a search based on the released location information. The server sends the resource to the second user after the verification succeeds. Based on the method, the following cumbersome process can be alleviated: A resource acquirer searches for a specific target object at a specified location and collects an image. As such, resources can be conveniently obtained.

### CROSS-REFERENCE TO RELATED APPLICATIONS

This application is a continuation of PCT Application No. PCT/CN2018/082766, filed on Apr. 12, 2018, which claims priority to Chinese Patent Application No. 201710242797.X, filed on Apr. 14, 2017, and each application is hereby incorporated by reference in its entirety.

### TECHNICAL FIELD

The present application relates to the field of computer technologies, and in particular, to resource transmission methods and apparatus.

### BACKGROUND

As information technologies develop, resources (such as files or account quotas) can be transmitted between users by using an end-user device or an application running on an end-user device.

There is a resource transmission mode of combining augmented reality (AR) with a location based service (LBS) in the existing technology, changing a conventional instant transmission mode. In the present mode, a resource sender (referred to as a first user below) can collect an image of a certain target object (for example, a certain object) at any location by using an end-user device, and set a resource to be sent based on the collected image and information about the location. Correspondingly, a resource acquirer (referred to as a second user below) can collect the image of the same target object at the same location by using an end-user device, to obtain the resource sent by the first user.

For example, in an AR red envelope scenario, the first user can collect a photograph of a specific object at a certain location by using a mobile phone, and send an AR red envelope based on the photograph. The second user can identify, by using a location service, a location where the first user sends the AR red envelope. After arriving at the location, the second user can obtain the AR red envelope by collecting an image of the same object by using a mobile phone.

However, in the described resource transmission mode, the second user may spend a relatively long time in searching for a corresponding target object and collecting an image at a location of a resource. Apparently, the second user may spend more time in obtaining resources in the method.

### SUMMARY

Implementations of the present application provide resource transmission methods and apparatus, to alleviate a problem that it is inconvenient to obtain a resource by combining augmented reality with a location service in the existing technology.

An implementation of the present application provides a resource transmission method, including the following: receiving a resource sending request of a first user, where the resource sending request includes at least a resource to be sent, a user question matching the resource, and location information corresponding to the resource; and releasing the location information to verify a second user based on the user question when the second user obtains the resource through a search based on the released location information, and sending the resource to the second user after the verification succeeds.

An implementation of the present application further provides a resource transmission method, including the following: receiving a resource sending operation; generating a resource sending request based on the resource sending operation, where the resource sending request includes at least a resource to be sent, a user question matching the resource, and location information corresponding to the resource; and sending the resource sending request to a server, so that the server releases the location information, verifies, based on the user question, a second user obtaining the resource based on the location information, and sends the resource to the second user after the verification succeeds.

An implementation of the present application further provides a resource transmission method, including the following: detecting whether a second user triggers a question verification condition of a sent resource; sending a user question corresponding to the sent resource to the second user in response to detecting that the second user triggers the question verification condition, so that the second user feeds back an answer to be verified based on the user question; receiving and verifying the answer to be verified that is fed back by the second user; and sending the resource to the second user when the verification succeeds.

An implementation of the present application further provides a resource transmission method, including the following: receiving a user question that is sent by a server and that corresponds to a sent resource, after a question verification condition of the resource is triggered, where the resource is sent by a first user to the server, and the server releases location information of the resource; feeding back an answer to be verified to the server based on the user question, so that the server verifies the answer to be verified and feeds back the resource after the verification succeeds; and obtaining the resource fed back by the server.

An implementation of the present application further provides a resource transmission method, including the following: receiving a merchandise redemption code sent by a second user; verifying, based on a stored merchandise redemption code, the merchandise redemption code sent by the second user, where the stored merchandise redemption code is generated and sent by a server after information about a transaction with a first user is sent to the server; and providing merchandise corresponding to the merchandise redemption code for the second user after the verification succeeds.

An implementation of the present application further provides a resource transmission apparatus, including the following: a receiving module, configured to receive a resource sending request of a first user, where the resource sending request includes at least a resource to be sent, a user question matching the resource, and location information corresponding to the resource; and a releasing module, configured to release the location information to verify a second user based on the user question when the second user obtains the resource through a search based on the released location information, and send the resource to the second user after the verification succeeds.

An implementation of the present application further provides a resource transmission apparatus, including the following: a receiving module, configured to receive a resource sending operation; a request generation module, configured to generate a resource sending request based on the resource sending operation, where the resource sending request includes at least a resource to be sent, a user question matching the resource, and location information corresponding to the resource; and a sending module, configured to send the resource sending request to a server, so that the server releases the location information, verifies, based on the user question, a second user obtaining the resource based on the location information, and sends the resource to the second user after the verification succeeds.

An implementation of the present application further provides a resource transmission apparatus, including the following: a detection module, configured to detect whether a second user triggers a question verification condition of a sent resource; a question feedback module, configured to send a user question corresponding to the sent resource to the second user in response to detecting that the second user triggers the question verification condition, so that the second user feeds back an answer to be verified based on the user question; a verification module, configured to receive and verify the answer to be verified that is fed back by the second user; and a resource sending module, configured to send the resource to the second user when the verification succeeds.

An implementation of the present application further provides a resource transmission apparatus, including the following: a receiving module, configured to receive a user question that is sent by a server and that corresponds to a sent resource, after a question verification condition of the resource is triggered, where the resource is sent by a first user to the server, and the server releases location information of the resource; an answer sending module, configured to feed back an answer to be verified to the server based on the user question, so that the server verifies the answer to be verified and feeds back the resource after the verification succeeds; and an acquisition module, configured to obtain the resource fed back by the server.

An implementation of the present application further provides a resource transmission apparatus, including the following: a receiving module, configured to receive a merchandise redemption code sent by a second user; a verification module, configured to verify, based on a stored merchandise redemption code, the merchandise redemption code sent by the second user, where the stored merchandise redemption code is generated and sent by a server after information about a transaction with a first user is sent to the server; and a resource providing module, configured to provide merchandise corresponding to the merchandise redemption code for the second user after the verification succeeds.

The implementations of the present application provide the resource transmission method and apparatus. Based on the method, the following can be implemented:

When sending a resource to the server, a resource sender (namely, the first user) further sends a user question matching the resource to the server. The user question is used to verify a resource acquirer (namely, the second user). The server further obtains location information of the first user as location information of the resource. Then, the server releases the location information, so that another user can identify the resource corresponding to the location information based on a location service. Certainly, the server can verify the second user based on the user question set by the first user once a user identifying the resource needs to obtain the resource. The server sends the resource to the user only when the verification on the second user succeeds, so that the user obtains the resource.

Compared with the existing technology, the user question is set to alleviate a cumbersome process that a resource acquirer searches for a specific target object at a specified location and collects an image. As such, resources can be conveniently and simply obtained, and a resource acquisition process can be simplified.

### BRIEF DESCRIPTION OF DRAWINGS

The accompanying drawings described here are used to provide further understanding of the present application, and constitute a part of the present application. Schematic implementations of the present application and descriptions of the implementations are used to explain the present application, and do not constitute an improper limitation to the present application. In the accompanying drawings:

FIG. 1a is a schematic diagram illustrating an example of an architecture that a resource transmission method is based on, according to an implementation of the present application;

FIG. 1b and FIG. 1c are schematic diagrams illustrating an example of a resource sending process, according to an implementation of the present application;

FIG. 2a and FIG. 2b are schematic diagrams illustrating an example of an architecture in practice, according to an implementation of the present application;

FIG. 3a to FIG. 3c are schematic diagrams illustrating an example of a resource acquisition process, according to an implementation of the present application;

FIG. 4a and FIG. 4b are schematic diagrams illustrating an example of a virtual gift packet, according to an implementation of the present application; and

FIG. 5 to FIG. 9 are schematic structural diagrams illustrating an example of a resource transmission apparatus, according to an implementation of the present application.

### DESCRIPTION OF IMPLEMENTATIONS

To make the objectives, technical solutions, and advantages of the present application clearer, the following clearly and comprehensively describes the technical solutions of the present application with reference to specific implementations and corresponding accompanying drawings in the present application. Apparently, the described implementations are merely some but not all of the implementations of the present application. All other implementations obtained by a person of ordinary skill in the art based on the implementations of the present application without creative efforts shall fall within the protection scope of the present application.

As described above, in a resource transmission mode of combining AR with an LBS in the existing technology, a user looking for obtaining a resource needs to arrive at a certain location and collect an image of a specific target object at the location (for example, any object at the location such as a cup, a desk, or a chair, or any space area at the location), to obtain a resource sent by another user. However, the user usually needs to spend a lot of time in searching for the specific target object at the location after arriving at the location. Apparently, the method is very cumbersome and inconvenient for the user looking for obtaining a resource.

Based on the above, the present application provides a resource transmission method. By using a user question method, a user looking for obtaining a resource only needs to enter a correct answer corresponding to a user question in a corresponding end-user device instead of searching for a specific target object at a specified location, to obtain a resource sent by another user, thereby facilitating resource acquisition.

It is worthwhile to note that the resource described in the implementations of the present application includes but is not limited to a multimedia file (such as a video file, an audio file, or a dynamic picture), a character message, an account amount, a sum, a virtual article (such as a virtual red envelope), and a resource redemption code. The resource can be locally stored in an end-user device, or can be stored in an account of a user using the end-user device. No limitation is imposed on the present application here.

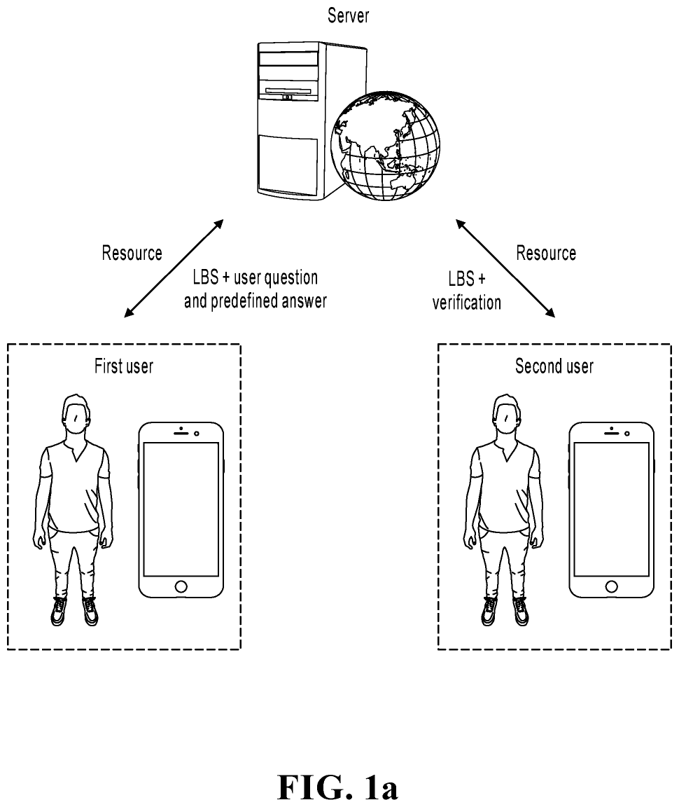

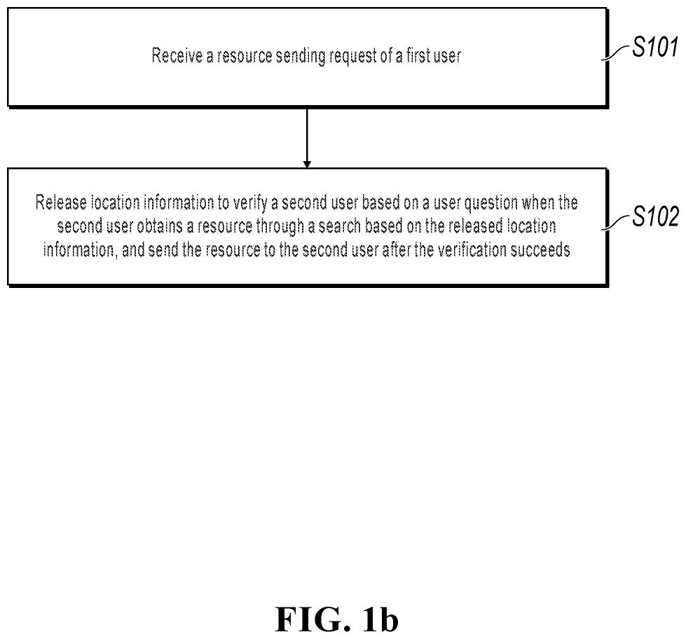

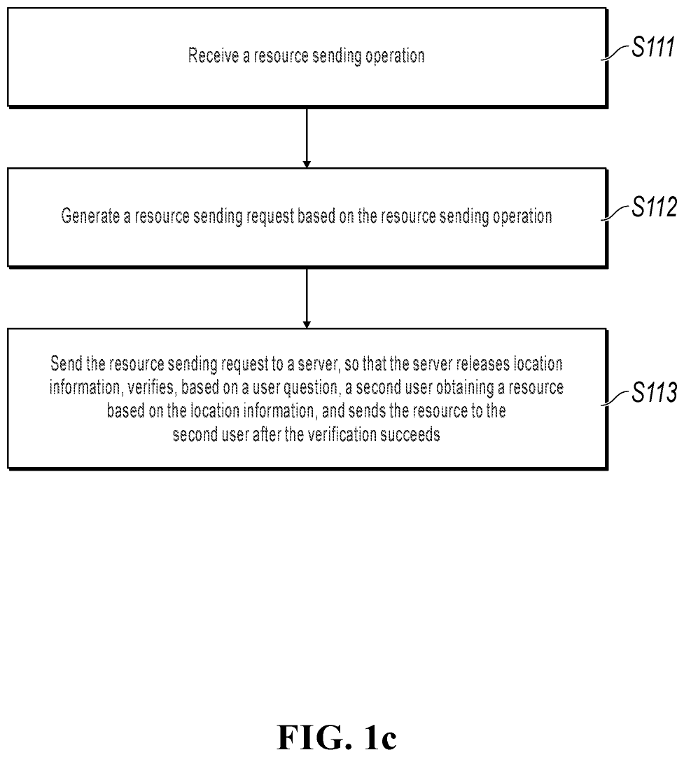

An architecture shown in FIG. 1a can be used for the resource transmission method in the implementations of the present application, and includes a first user (namely, a resource sender), a second user (namely, a resource acquirer), and a server.

The server can be a service server at a back end of a service provider (for example, a website, a bank, or a telecommunications operator). It can be seen from FIG. 1a that the first user or the second user can be understood as a user or an end-user device used by the user. The first user or the second user can implement resource sending and acquisition by using an application running in the end-user device or a resource transmission function of an operating system of the end-user device. In some descriptions of the implementations of the present application, the first user or the second user can also be understood as a user using an end-user device. The end-user device can include but is not limited to a smartphone, a smartwatch, a tablet computer, a computer, and a cash register.

Certainly, in practice, the first user can also obtain a resource sent by another user. As such, the first user can be considered as a resource acquirer (namely, the second user). Similarly, the second user can also send a resource to another user. As such, the second user can be considered as a resource sender (namely, the first user). No limitation is imposed on the present application here.

The following describes in detail the resource transmission method provided in the implementations of the present application.

### Resource Sending Phase

Based on the architecture shown in FIG. 1a, on a server side, a resource transmission process provided in the present implementation of the present application is shown in FIG. 1b, and includes the following steps.

S101. Receive a resource sending request of a first user.

The resource sending request includes at least a resource to be sent, a user question matching the resource, and location information corresponding to the resource.

In the present implementation of the present application, the resource sending request sent by the first user can further include information such as a quantity of resources set by the first user, a resource acquisition permission (for example, the first user can set that any user can obtain the resource or only a friend of the first user can obtain the resource), and user information (for example, a user ID and an account name) of the first user. No limitation is imposed here.

Different from a method for collecting a target object image in the existing technology, in the present implementation of the present application, the first user sets a corresponding user question and a predefined answer, and the user question is used to verify a resource acquirer. It can be understood that the resource acquirer can obtain the resource only after entering answer information consistent with the predefined answer.

The user question and the predefined answer can be set by the first user in a user-defined method or by using a question library (to be specific, selected by the first user from the question library). No limitation is imposed here. In addition, a format of the user question can be a text format formed by characters such as a word, a digit, and a symbol, or can be a multimedia format such as a voice or a short video. Correspondingly, a format of the predefined answer can match the format of the user question. Similarly, formats of the user question and the predefined answer in the present implementation of the present application do not constitute a limitation on the present application.

The location information can be information about a location, of the first user at a current moment, determined by the first user based on a location service (for example, the described LBS), or can be location information corresponding to a resource provider certainly.

S102. Release location information to verify a second user based on a user question when the second user obtains a resource through a search based on the released location information, and send the resource to the second user after the verification succeeds.

The server can release the location information after determining the location information of the resource. It can be understood that the released location information can be identified by another user by using a location service. As such, a user identifying the resource can obtain the resource. The verification is performed on the second user based on the user question and the predefined answer because the first user sets the user question and the predefined answer for the resource. The second user can obtain the resource only after the verification on the second user succeeds. In other words, the server can send the resource of the first user to the resource acquirer (namely, the second user) after the verification succeeds.

By using the described steps, while sending the resource to the server, a resource sender (namely, the first user) further sends, to the server, the user question and the predefined answer that match the resource. The user question and the predefined answer are used to verify the resource acquirer (namely, the second user). The server further obtains the location information of the first user as the location information of the resource. Then, the server releases the location information so that another user can identify the resource corresponding to the location information based on the location service. Certainly, once the user identifying the resource needs to obtain the resource, the server can verify the second user based on the user question and the predefined answer that are set by the first user. The server sends the resource to the user only when the verification on the second user succeeds, so that the user obtains the resource.

Compared with the existing technology, the user question is set to alleviate a cumbersome process that a resource acquirer searches for a specific target object at a specified location and collects an image. As such, resources can be conveniently and simply obtained, and a resource acquisition process can be simplified.

For the first user, a resource transmission process provided in the present implementation of the present application is shown in FIG. 1c, and includes the following steps.

S111. Receive a resource sending operation.

The resource sending operation can be initiated by the first user to an end-user device of the first user, to instruct the end-user device to send a resource to the server. In practice, the resource sending operation can include a setting operation for a resource that needs to be sent, and editing operations for a user question and a predefined answer. No limitation is imposed on the present application here.

S112. Generate a resource sending request based on the resource sending operation.

After the user initiates the transmission operation, the end-user device can determine the resource, the user question, and the predefined answer corresponding to the resource sending operation, to generate the corresponding resource sending request. Therefore, in the present implementation of the present application, the resource sending request includes at least a resource to be sent, a user question matching the resource, and location information corresponding to the resource.

S113. Send the resource sending request to a server, so that the server releases location information, verifies, based on a user question, a second user obtaining a resource based on the location information, and sends the resource to the second user after the verification succeeds.

After the server receives the resource sending request sent by the first user, the subsequent steps can be performed by the server with reference to the previously described methods. Details are omitted here for simplicity.

It is worthwhile to note that, based on the described methods shown in FIG. 1b and FIG. 1c, the resource sent by the first user can be information for redeeming a resource (for example, a merchandise redemption code), that is, resource redemption information in practice in some implementations of the present application. In other words, the second user can use the resource redemption information to redeem a certain resource after obtaining the resource redemption information sent by the first user.

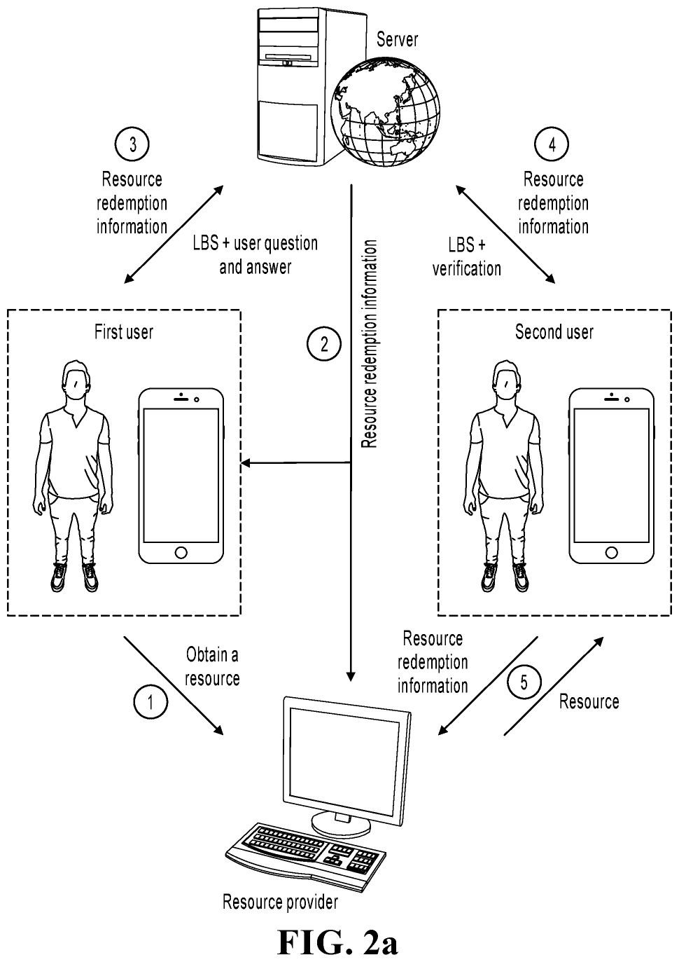

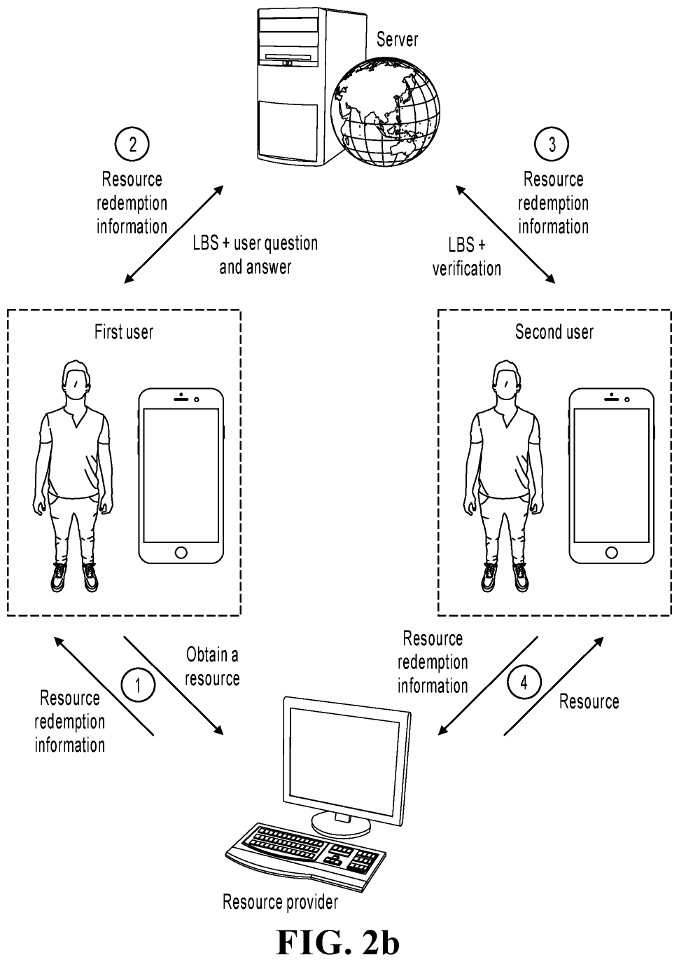

In a method in the present scenario, an architecture can be shown in FIG. 2a. Compared with the architecture shown in FIG. 1a, a resource provider is added to the architecture in FIG. 2a. The resource provider can include an offline merchant, a telecommunications operator, a bank, etc. The resource redemption information can be generated by the server in the described methods. It should be understood that, in the architecture shown in FIG. 2a, the server provides a resource redemption information service. In other words, the server can send the same resource redemption information to the first user and the resource provider (usually when the first user obtains a resource provided by the resource provider).

For example, based on the architecture shown in FIG. 2a, the first user can use the resource redemption information service provided by the server after purchasing certain merchandise (however, the first user does not hold the purchased merchandise) of the offline merchant (namely, the resource provider). In other words, the server separately sends the same merchandise redemption code to the first user and the offline merchant. Similar to the described example, the first user sends the merchandise redemption code to the server as the resource to be sent, and releases a location of the merchandise redemption code by using the server. The second user can redeem the merchandise from the offline merchant after obtaining the merchandise redemption code, and the offline merchant can perform verification based on a stored resource redemption code.

In practice, the server shown in FIG. 2a can be considered as a server of a service platform (for example, a payment platform or a bank). In other words, resource interaction between the first user and the resource provider (for example, the first user purchases certain merchandise from the resource provider) is completed with support of the server. As such, the server sends the resource redemption information to the first user and the resource provider based on an identifier such as accounts and user IDs of the first user and the resource provider on the platform. Apparently, the server sends the same resource redemption information to the first user and the resource provider.

Based on an architecture shown in FIG. 2b, it can be seen that the first user first needs to obtain the resource redemption information and then sends the resource sending request to the server, so that the server releases a location of the resource redemption information.

As such, for the first user, before the receiving a resource sending operation, the method further includes the following: sending a redemption information acquisition request to the server, so that the server feeds back resource redemption information corresponding to the redemption information acquisition request; and receiving the resource redemption information which is determined as the resource to be sent.

Correspondingly, for the server, before the receiving a resource sending request of a first user, the method further includes the following: receiving a redemption information acquisition request sent by the first user; and generating resource redemption information based on the redemption information acquisition request, and feeding back the resource redemption information to the first user. As such, the receiving a resource sending request of a first user includes the following: receiving the resource sending request that is sent by the first user and that uses the resource redemption information as a resource.

The first user can obtain the resource redemption information in two cases:

Case 1: After the first user completes a transaction with the resource provider (for example, an offline merchant), the server actively queries the first user whether to obtain the resource redemption information.

Case 2: The first user can actively initiate an operation of obtaining the resource redemption information at any time after completing a transaction with the resource provider (for example, an offline merchant).

The following describes the two cases in practice (the resource redemption information is a merchandise redemption code and the resource provider is an offline merchant).

### Case 1

The server provides a payment service. In other words, both the first user and the offline merchant use the payment service provided by the server. As such, after the first user and the offline merchant complete a transaction, the server obtains transaction information. For the server, before the receiving a redemption information acquisition request sent by the first user, the method further includes the following: receiving information about a transaction between the first user and an offline merchant providing a resource redemption service, and initiating a resource sending query to the first user.

The transaction information can include a transaction order number, user information of two users in a transaction, etc.

As such, the first user can send a corresponding request based on the query of the server if the first user is looking for obtaining the merchandise redemption code. Further, the generating resource redemption information and feeding back the resource redemption information to the first user includes the following: determining user information of the first user and user information of the offline merchant based on the transaction information; generating a resource redemption code corresponding to the user information of the first user and the user information of the offline merchant; and feeding back the resource redemption code to the first user and the offline merchant.

### Case 2

The first user actively initiates a merchandise redemption code request after purchasing certain merchandise from the offline merchant. For the first user, the sending a redemption information acquisition request to the server includes the following: obtaining user information of the first user and user information of the offline merchant providing a resource redemption service; and sending a merchandise redemption code request including the user information of the first user and the user information of the offline merchant to the server.

Correspondingly, for the server, the receiving a redemption information acquisition request sent by the first user includes the following: receiving a merchandise redemption code request that is sent by the first user and that includes the user information of the first user and the user information of the offline merchant providing the resource redemption service.

Certainly, the described content imposes no limitation on the present application.

In addition, in another method in the present scenario, the resource redemption information can be generated by the resource provider.

For example, based on the architecture shown in FIG. 2b, the first user purchases certain merchandise from the offline merchant. As such, the offline merchant can generate a merchandise redemption code (namely, the resource redemption information) for the first user. Therefore, the first user can use the merchandise redemption code as a resource to be sent, add the merchandise redemption code to the resource sending request, and send the resource sending request to the server; and the server releases location information of the resource. As such, another user obtaining the merchandise redemption code can use the merchandise redemption code to redeem the merchandise purchased by the first user in the corresponding offline merchant.

Certainly, in practice, after generating the resource redemption information for the first user, the resource provider can send the resource redemption information to the first user by using instant messaging (IM), a short message service (SMS), etc., so that the first user sends the resource redemption information to the server. No limitation is imposed here.

Certainly, no limitation is imposed on the present application here.

Another user can identify the resource information based on a location service and further obtain the resource because the server releases the location of the resource sent by the first user. The following describes a resource acquisition process.

### Resource Acquisition Phase

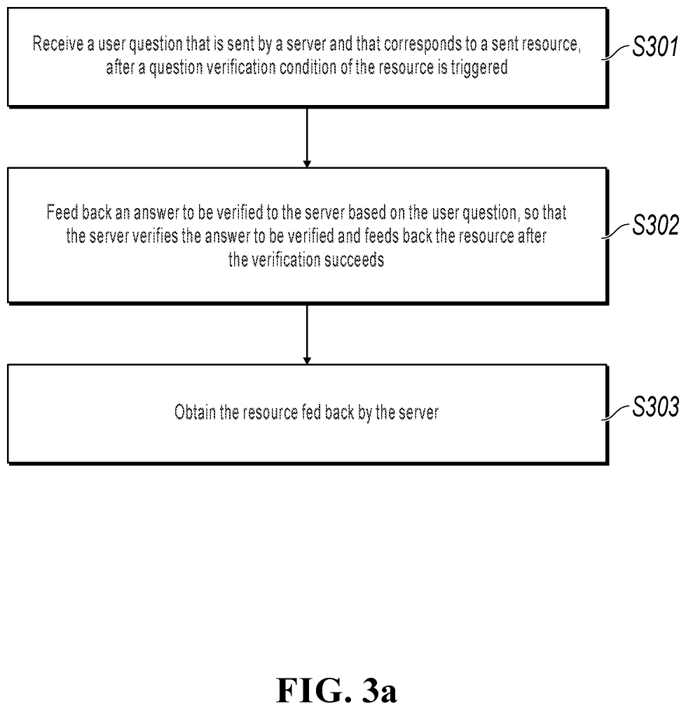

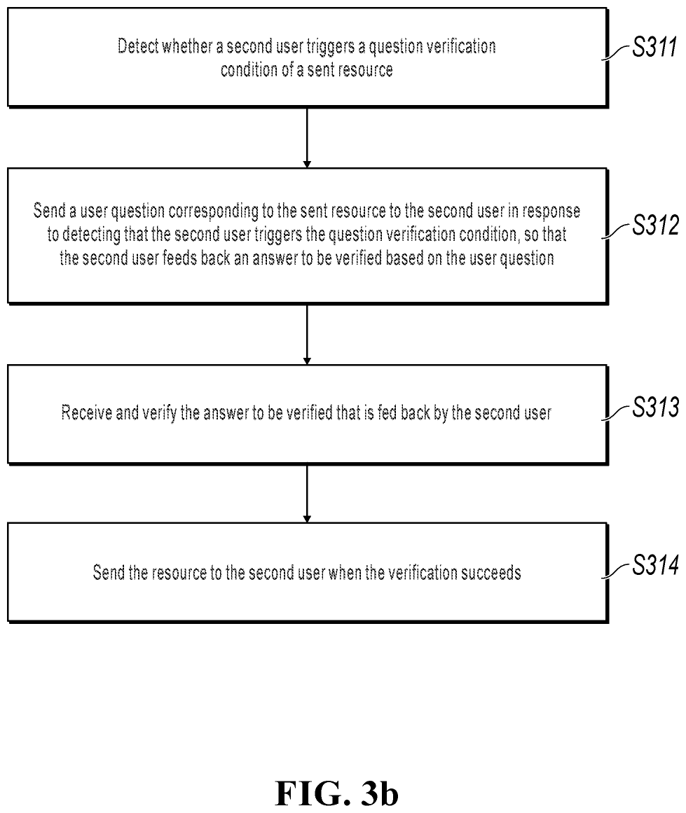

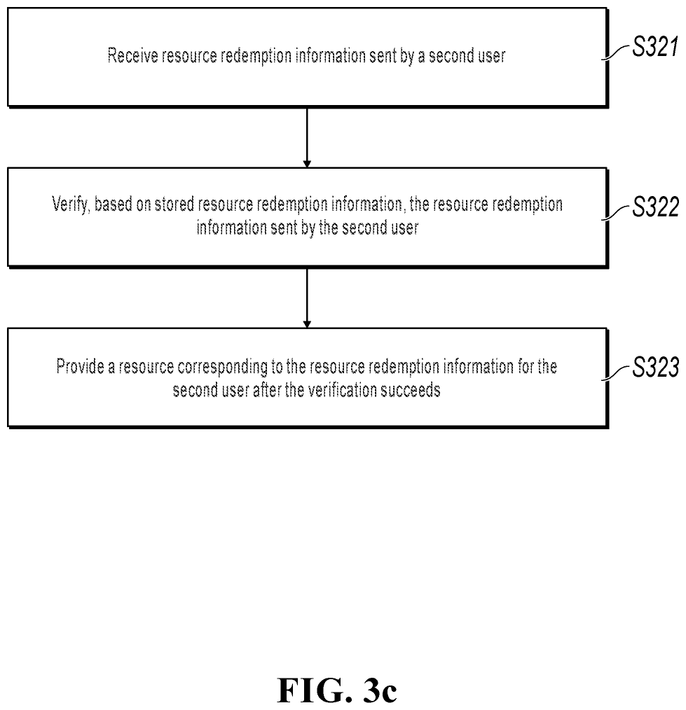

For the second user, a resource transmission process provided in the present implementation of the present application is shown in FIG. 3a, and includes the following steps.

S301. Receive a user question that is sent by a server and that corresponds to a sent resource, after a question verification condition of the resource is triggered.

The resource is sent by the first user to the server, and the server releases location information of the resource.

In the present implementation of the present application, triggering the question verification condition can include the following: The second user actively searches for the sent resource based on the location service and obtains the resource; or the server detects that a location of the second user is within a specified range of a location of the sent resource.

In other words, triggering the question verification condition of the sent resource includes the following: sending a request of obtaining the resource identified based on the released location information to the server; or detecting that the location of the second user is within the specified range of the location of the sent resource.

The server sends a corresponding user question to the second user once the second user triggers the question verification condition.

Certainly, in the present implementation of the present application, the second user can search, by using the location service, for a location where the first user sends a resource. In other words, the sending a request of obtaining the resource identified based on the released location information to the server includes the following: determining information about a current location; searching for the released resource location information in a specified range of the location; and receiving an instruction of obtaining the identified resource, generating the acquisition request, and sending the acquisition request to the server.

S302. Feed back an answer to be verified to the server based on the user question, so that the server verifies the answer to be verified and feeds back the resource after the verification succeeds.

As described above, the first user sets the corresponding user question for the resource sent to the server. As such, the server sends the user question corresponding to the resource to the second user for verification.

S303. Obtain the resource sent by the server.

The above is an execution process based on a side of the second user. For the server, an implementation of the present application further provides a resource transmission method. As shown in FIG. 3b, the method includes the following steps.

S311. Detect whether a second user triggers a question verification condition of a sent resource.

Triggering the question verification condition is the same as the previously described content. In other words, the detecting whether a second user triggers a question verification condition of a sent resource includes the following: detecting and receiving a resource acquisition request sent by the second user for the sent resource; or detecting that a location of the second user is within a specified range of a location of the sent resource.

S312. Send a user question corresponding to the sent resource to the second user in response to detecting that the second user triggers the question verification condition, so that the second user feeds back an answer to be verified based on the user question.

S313. Receive and verify the answer to be verified that is fed back by the second user.

S314. Send the resource to the second user when the verification succeeds.

Similar to the described content, the architecture shown in FIG. 2a or FIG. 2b can also be used in the resource acquisition phase. It is worthwhile to note here that, in the present implementation of the present application, the server sets a corresponding limitation condition for the second user. The method shown in FIG. 3b further includes the following: determining user information of the second user sending the resource acquisition request; counting a quantity of resource acquisition requests sent by the second user or a quantity of verification times based on the user information; and feeding back predetermined overrun prompt information to the second user when the quantity of resource acquisition requests or the quantity of verification times exceeds a specified quantity. It can be seen that the second user cannot obtain the resource once the second user exceeds a limitation condition set by the server.

Correspondingly, for the second user, the method further includes the following: receiving and displaying the overrun prompt information fed back by the server. In other words, an end-user device of the second user displays the overrun prompt information to indicate that a resource cannot be obtained currently.

Certainly, the limitation to the quantity can be valid in a specific time period. For example, the quantity takes effect every natural day, and the quantity is updated on a next natural day. No limitation is imposed on the present application here.

Certainly, for the resource provider in FIG. 2a, an implementation of the present application provides a resource transmission method based on a side of the resource provider. As shown in FIG. 3c, the method includes the following steps.

S321. Receive resource redemption information sent by a second user.

S322. Verify, based on stored resource redemption information, the resource redemption information sent by the second user.

The stored resource redemption information is generated and sent by the server after information about a transaction with the first user is sent to the server.

S323. Provide a resource corresponding to the resource redemption information for the second user after the verification succeeds.

In other words, the resource provider first completes an operation such as payment with the first user, so that some resources belong to the first user (for example, if the first user purchases certain merchandise, the merchandise belongs to the first user), and resource redemption information generated by the server is further obtained. Correspondingly, the first user can release a location of the resource redemption information by using the server. As such, the second user obtaining the resource redemption information can obtain, from the resource provider, a resource that originally belongs to the first user.

Certainly, for the resource provider in FIG. 2b, similar steps can be performed. Details are omitted here for simplicity.

It is worthwhile to note that the resource transmission method in the present implementation of the present application is applicable to a virtual red envelope scenario. The following describes the described method in the present implementation of the present application based on the virtual red envelope scenario (a schematic flowchart of method steps described in the present scenario is not provided).

First, a transaction between the first user and the offline merchant is completed. In other words, the first user purchases certain merchandise from the offline merchant and obtains a merchandise redemption code by using the server.

Based on the above, a process of sending a virtual red envelope is as follows:

In the present scenario, on a side of the server, the following steps can be included:

S401. Receive a virtual red envelope sent by a first user, and a red envelope question and a red envelope answer that match the virtual red envelope. A virtual red envelope sending request includes at least one of a merchandise redemption code to be sent, a user question matching the merchandise redemption code, and location information corresponding to the virtual red envelope.

S402. Release the location information to verify a second user based on the user question when the second user obtains the virtual red envelope through a search based on the released location information, and send the merchandise redemption code in the virtual red envelope to the second user after the verification succeeds.

On a side of the first user, the following steps can be included:

S501. Receive a red envelope sending operation.

S502. Generate a virtual red envelope sending request based on the red envelope sending operation, where the virtual red envelope sending request includes at least one of a merchandise redemption code to be sent, a user question matching the merchandise redemption code, and location information corresponding to a virtual red envelope.

S503. Send the virtual red envelope sending request to a server, so that the server releases the location information, verifies, based on a red envelope question, a second user obtaining the virtual red envelope based on the location information, and sends the merchandise redemption code in the virtual red envelope to the second user after the verification succeeds.

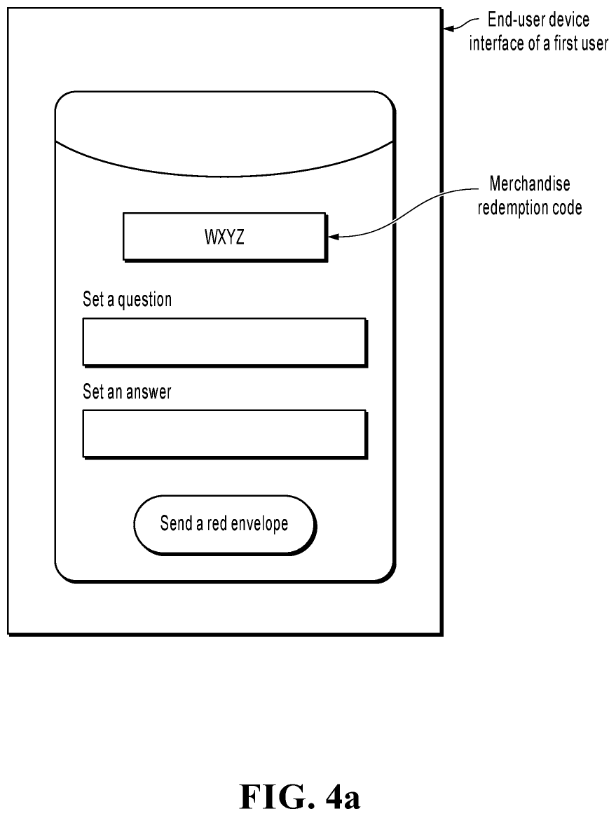

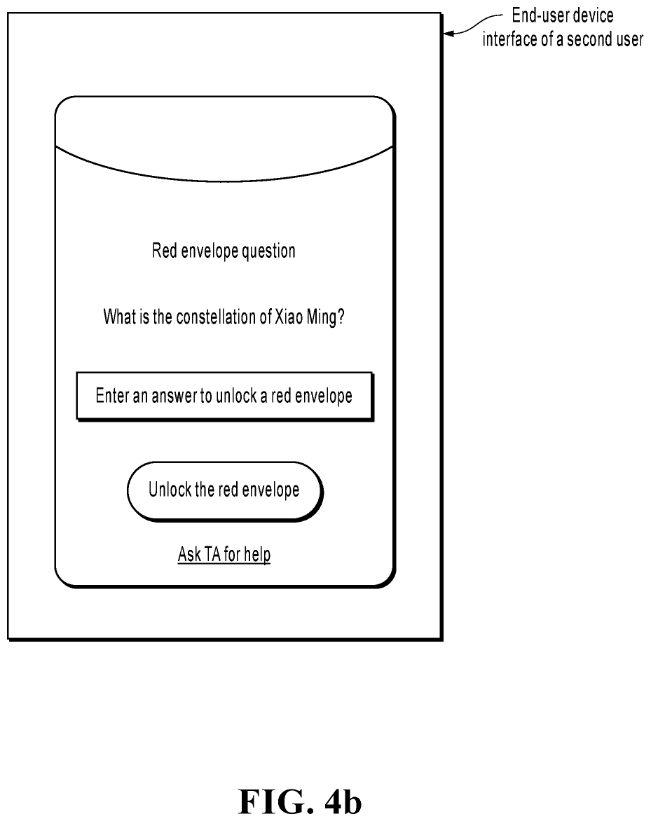

In a process of sending a virtual red envelope, the first user can use an end-user device to set a virtual red envelope to be sent in practice. For example, the first user can send a virtual red envelope when purchasing certain merchandise from an offline merchant and obtaining a merchandise redemption code (the merchandise redemption code is generated by the server). As shown in FIG. 4a, a virtual red envelope interface is displayed in an end-user device interface of the first user, and the first user can set a red envelope question and a red envelope answer in the virtual red envelope interface. The end-user device can send the virtual red envelope to the server based on the described method steps after the user taps a “red envelope” control. Details are omitted here for simplicity.

A process of obtaining a virtual red envelope is as follows:

On a side of the server, the following steps can be included:

S601. Detect whether a second user triggers a red envelope question verification condition of a sent virtual red envelope.

S602. Send a red envelope question corresponding to the virtual red envelope to the second user in response to detecting that the second user triggers the red envelope question verification condition.

S603. Send a merchandise redemption code in the virtual red envelope to the second user.

On a side of the second user, the following steps can be included:

S701. Receive a red envelope question that is sent by a server and that corresponds to a sent virtual red envelope, after a question verification condition of the virtual red envelope is triggered.

S702. Feed back an answer to be verified to the server based on the red envelope question, so that the server verifies the answer to be verified and feeds back a merchandise redemption code in the virtual red envelope after the verification succeeds.

S703. Obtain the merchandise redemption code fed back by the server.

Based on the example shown in FIG. 4a, when the second user obtains the virtual red envelope, an end-user device interface can be shown as in FIG. 4b. In other words, the second user needs to enter corresponding information as the answer to be verified for the red envelope question displayed in the interface, to unlock the red envelope. In addition, in the present implementation of the present application, the second user can tap a function option “Ask TA for help” on the red envelope interface to initiate instant messaging chat with the first user, to consult the first user for an answer to the red envelope question.

Merchandise redemption process:

The second user can redeem merchandise from the offline merchant after obtaining the merchandise redemption code. In other words, the merchandise redemption process can include the following steps on a side of the offline merchant.

S801. Receive a merchandise redemption code sent by a second user.

S802. Verify, based on a stored merchandise redemption code, the merchandise redemption code sent by the second user, where the stored merchandise redemption code is generated and sent by a server after information about a transaction with a first user is sent to the server.

S803. Provide merchandise corresponding to the merchandise redemption code for the second user after the verification succeeds.

The above describes the resource transmission method provided in the implementation of the present application. Based on the same idea, an implementation of the present application further provides a resource transmission apparatus.

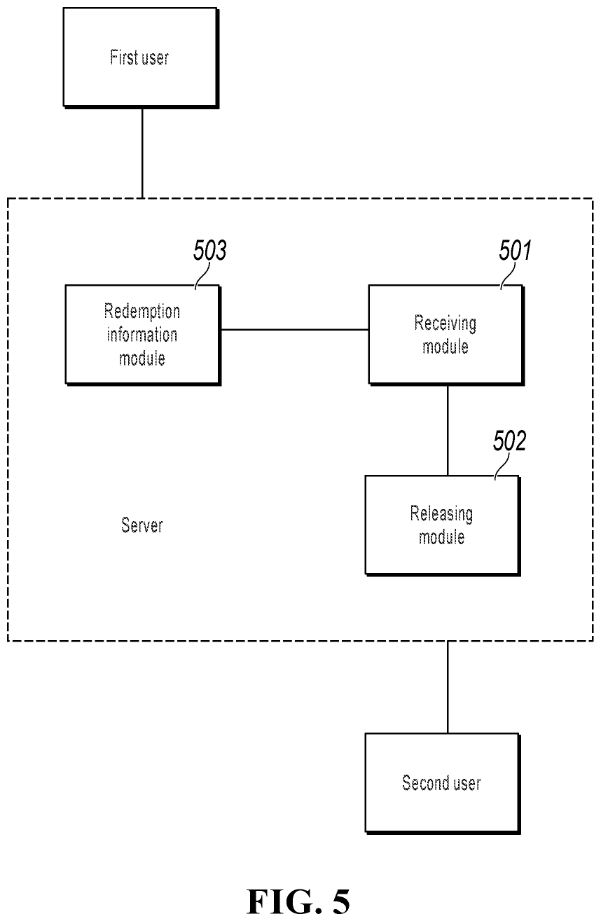

As shown in FIG. 5, the resource transmission apparatus is disposed on a server side, and includes the following: a receiving module 501, configured to receive a resource sending request of a first user, where the resource sending request includes at least a resource to be sent, a user question matching the resource, and location information corresponding to the resource; and a releasing module 502, configured to release the location information to verify a second user based on the user question when the second user obtains the resource through a search based on the released location information, and send the resource to the second user after the verification succeeds.

The apparatus further includes a redemption information module 503, configured to receive a redemption information acquisition request sent by the first user; generate resource redemption information after receiving the redemption information acquisition request; and feed back the resource redemption information to the first user.

The receiving module 501 receives the resource sending request that is sent by the first user and that uses the resource redemption information as a resource.

The resource redemption information includes at least a merchandise redemption code.

Before receiving the redemption information acquisition request sent by the first user, the redemption information module 503 receives information about a transaction between the first user and an offline merchant providing a resource redemption service, initiates a resource sending query to the first user, receives a merchandise redemption code request sent by the first user based on the resource sending query, determines user information of the first user and user information of the offline merchant based on the transaction information, generates a resource redemption code corresponding to the user information of the first user and the user information of the offline merchant, and feeds back the resource redemption code to the first user and the offline merchant.

The redemption information module 503 receives a merchandise redemption code request that is sent by the first user and that includes user information of the first user and user information of an offline merchant providing a resource redemption service.

Certainly, in an actual virtual red envelope scenario, the receiving module 501 receives the virtual red envelope sending request of the first user, where the virtual red envelope sending request includes at least one of a merchandise redemption code to be sent, a user question matching the merchandise redemption code, and location information corresponding to a virtual red envelope; and the releasing module 502 releases the location information to verify the second user based on the user question when the second user obtains the virtual red envelope through a search based on the released location information, and sends the merchandise redemption code in the virtual red envelope to the second user after the verification succeeds.

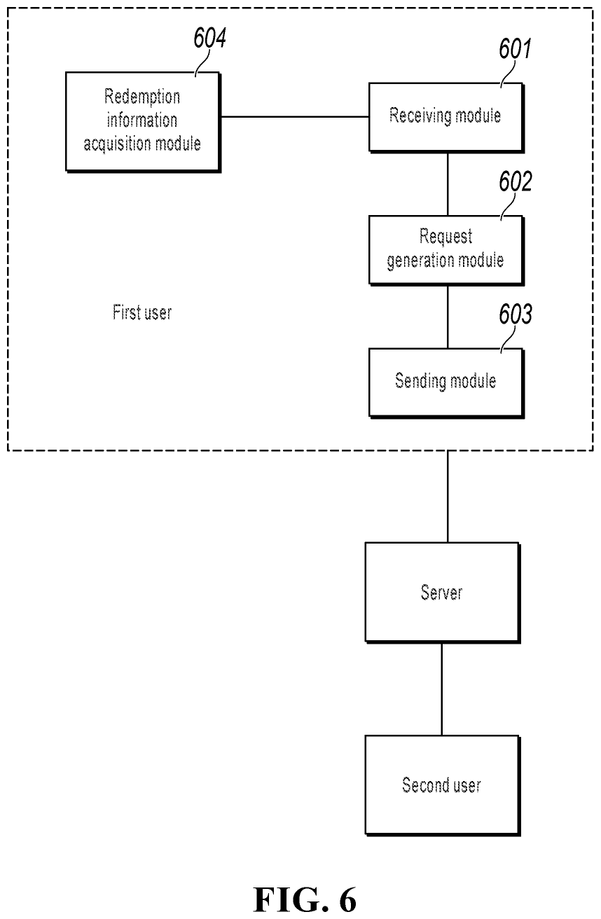

An implementation of the present application further provides a resource transmission apparatus on a side of a first user. As shown in FIG. 6, the apparatus includes the following: a receiving module 601, configured to receive a resource sending operation; a request generation module 602, configured to generate a resource sending request based on the resource sending operation, where the resource sending request includes at least a resource to be sent, a user question matching the resource, and location information corresponding to the resource; and a sending module 603, configured to send the resource sending request to a server, so that the server releases the location information, verifies, based on the user question, a second user obtaining the resource based on the location information, and sends the resource to the second user after the verification succeeds.

The apparatus further includes a redemption information acquisition module 604, configured to send a redemption information acquisition request to the server, so that the server feeds back resource redemption information corresponding to the redemption information acquisition request; and receive the resource redemption information which is determined as the resource to be sent.

The resource redemption information includes at least a merchandise redemption code.

Before sending the redemption information acquisition request to the server, the redemption information acquisition module 604 sends information about a transaction with an offline merchant to the server, and receives a resource sending query initiated by the server based on the transaction information.

The redemption information acquisition module 604 obtains user information of the first user and user information of an offline merchant providing a resource redemption service; and sends a merchandise redemption code request including the user information of the first user and the user information of the offline merchant to the server.

Certainly, in an actual virtual red envelope scenario, the receiving module 601 receives a red envelope sending operation; the request generation module 602 generates a virtual red envelope sending request based on the red envelope sending operation, where the virtual red envelope sending request includes at least one of a merchandise redemption code to be sent, a user question matching the merchandise redemption code, and location information corresponding to a virtual red envelope; and the sending module 603 sends the virtual red envelope sending request to the server, so that the server releases the location information, verifies, based on the red envelope question, the second user obtaining the virtual red envelope based on the location information, and sends the merchandise redemption code in the virtual red envelope to the second user after the verification succeeds.

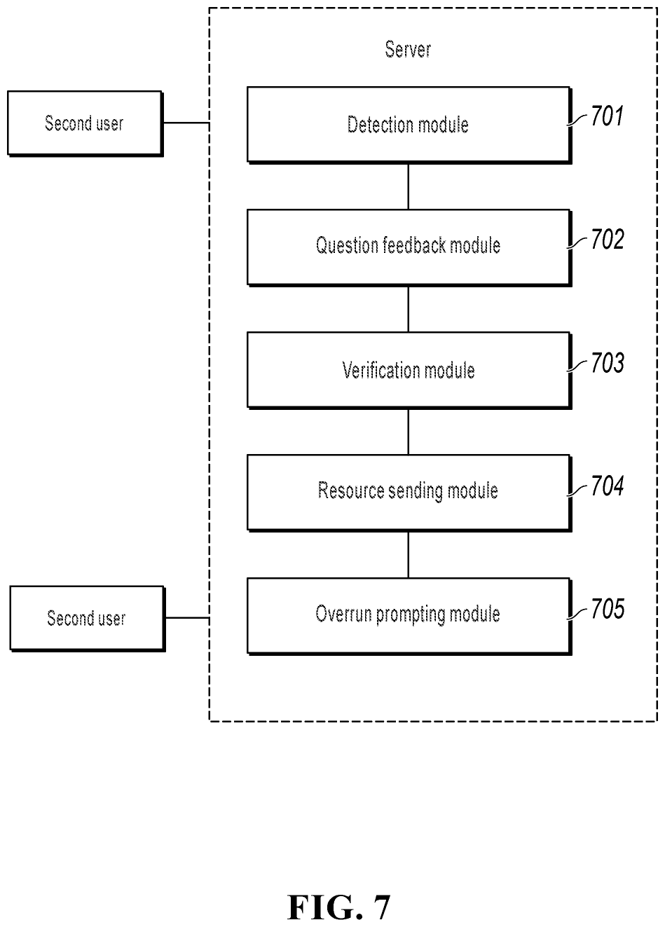

In a resource acquisition phase, an implementation of the present application further provides a resource transmission apparatus on a side of a server. As shown in FIG. 7, the apparatus includes the following: a detection module 701, configured to detect whether a second user triggers a question verification condition of a sent resource; a question feedback module, 702, configured to send a user question corresponding to the sent resource to the second user in response to detecting that the second user triggers the question verification condition, so that the second user feeds back an answer to be verified based on the user question; a verification module 703, configured to receive and verify the answer to be verified that is fed back by the second user; and a resource sending module 704, configured to send the resource to the second user when the verification succeeds.

The detection module 701 detects and receives a resource acquisition request sent by the second user for the sent resource; or detects that a location of the second user is within a specified range of a location of the sent resource.

The apparatus further includes an overrun prompting module 705, configured to determine user information of the second user sending a resource acquisition request; count a quantity of resource acquisition requests sent by the second user or a quantity of verification times based on the user information; and feed back predetermined overrun prompt information to the second user when the quantity of resource acquisition requests or the quantity of verification times exceeds a specified quantity.

Certainly, in an actual virtual red envelope scenario, the detection module 701 detects whether the second user triggers a red envelope question verification condition of a sent virtual red envelope; the question feedback module, 702 sends a red envelope question corresponding to the virtual red envelope to the second user in response to detecting that the second user triggers the red envelope question verification condition; and the resource sending module 704 sends a merchandise redemption code in the virtual red envelope to the second user.

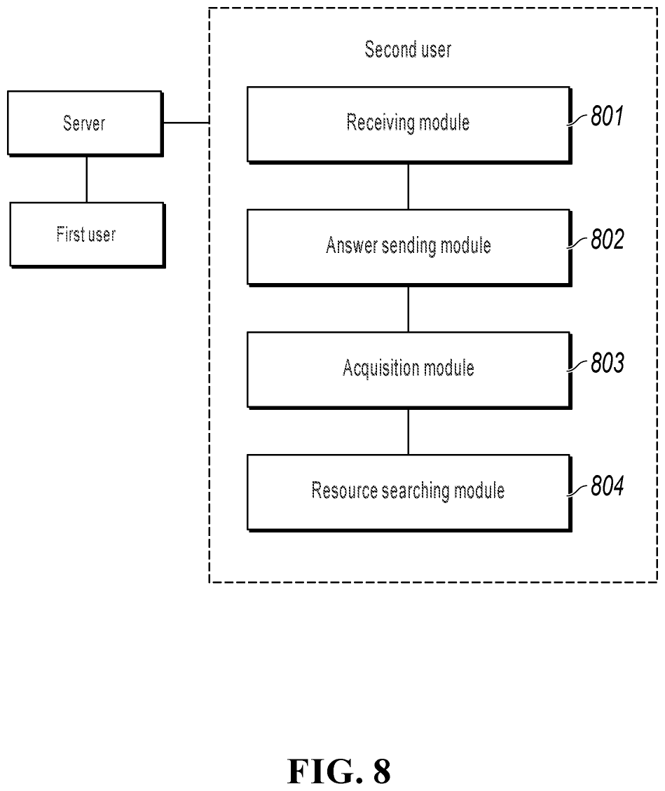

An implementation of the present application further provides a resource transmission apparatus on a side of a second user. As shown in FIG. 8, the apparatus includes the following: a receiving module 801, configured to receive a user question that is sent by a server and that corresponds to a sent resource, after a question verification condition of the resource is triggered, where the resource is sent by a first user to the server, and the server releases location information of the resource; an answer sending module 802, configured to feed back an answer to be verified to the server based on the user question, so that the server verifies the answer to be verified based on a predefined answer sent by the first user and feeds back the resource to the second user after the verification succeeds; and an acquisition module 803, configured to obtain the resource sent by the server.

Triggering the question verification condition of the sent resource can include the following: sending a request of obtaining the resource identified based on the released location information to the server; or detecting that a location of the second user is within a specified range of a location of the sent resource.

The apparatus further includes a resource searching module 804, configured to determine information about a current location; search for the released resource location information in a specified range of the location; and receive an instruction of obtaining the identified resource, generate the acquisition request, and send the acquisition request to the server.

The receiving module 801 receives and displays overrun prompt information fed back by the server.

Certainly, in an actual virtual red envelope scenario, the receiving module 801 receives a red envelope question that is sent by the server and that corresponds to a sent virtual red envelope, after a question verification condition of the virtual red envelope is triggered; the answer sending module 802 feeds back the answer to be verified to the server based on the red envelope question, so that the server verifies the answer to be verified and feeds back a merchandise redemption code in the virtual red envelope after the verification succeeds; and the acquisition module 803 obtains the merchandise redemption code fed back by the server.

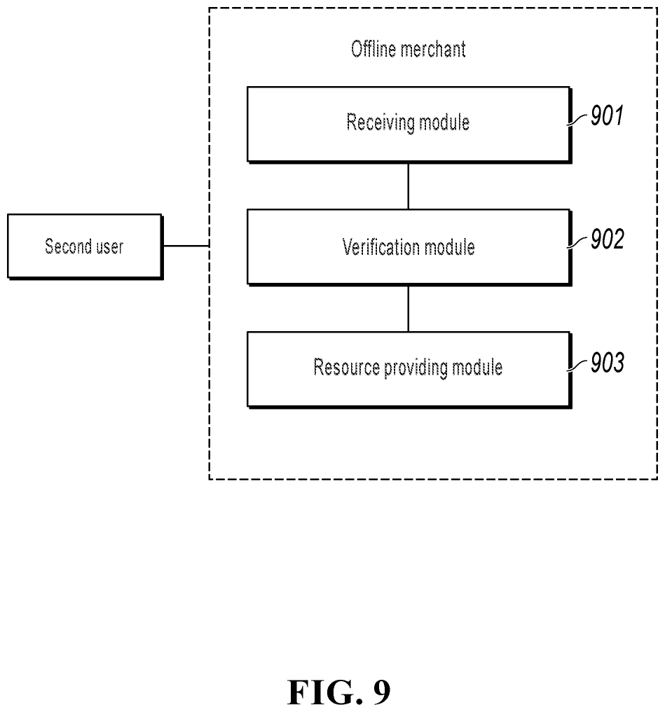

For an offline merchant, an implementation of the present application further provides a resource transmission apparatus. As shown in FIG. 9, the apparatus includes the following: a receiving module 901, configured to receive resource redemption information sent by a second user; a verification module 902, configured to verify, based on stored resource redemption information, the resource redemption information sent by the second user, where the stored resource redemption information is generated and sent by a server after information about a transaction with a first user is sent to the server; and a resource providing module 903, configured to provide a resource corresponding to the resource redemption information for the second user after the verification succeeds.

Certainly, in an actual virtual red envelope scenario, the receiving module 901 receives a merchandise redemption code sent by the second user; the verification module 902 verifies, based on a stored merchandise redemption code, the merchandise redemption code sent by the second user, where the stored merchandise redemption code is generated and sent by the server; and the resource providing module 903 provides merchandise corresponding to the merchandise redemption code for the second user after the verification succeeds.

In the 1990s, whether a technology improvement is a hardware improvement (for example, an improvement to a circuit structure, such as a diode, a transistor, or a switch) or a software improvement (an improvement to a method procedure) can be obviously distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, this type of programming is mostly implemented by using “logic compiler” software instead of manually manufacturing an integrated circuit chip. The programming is similar to a software compiler used for program development and compiling. However, original code before compiling needs to be written in a particular programming language. The language is referred to as a hardware description language (HDL). There are many types of HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Currently, Very-High-Speed Integrated Circuit Hardware Description Language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor, or a processor, or a computer-readable medium, a logic gate, a switch, an application-specific integrated circuit (ASIC), a programmable logic controller, or a built-in microprocessor that stores computer readable program code (such as software or firmware) that can be executed by the microprocessor or the processor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using the computer-readable program code, logic programming can be performed on method steps to enable the controller to implement the same function in forms of the logic gate, the switch, the application-specific integrated circuit, the programmable logic controller, the built-in microcontroller, etc. Therefore, the controller can be considered as a hardware component, and an apparatus configured to implement various functions in the controller can also be considered as a structure in the hardware component. Alternatively, an apparatus configured to implement various functions can be considered as both a software module for implementing the method and a structure in the hardware component.

The system, apparatus, module, or unit described in the described implementations can be implemented by a computer chip or an entity, or implemented by using a product with a certain function. A typical implementation device is a computer. The computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the described apparatus is described by dividing functions into various units. Certainly, when the present application is implemented, a function of each unit can be implemented in one or more pieces of software and/or hardware.

A person skilled in the art should understand that the implementations of the present invention can be provided as a method, a system, or a computer program product. Therefore, the present invention can use a form of hardware only implementations, software only implementations, or implementations with a combination of software and hardware. In addition, the present invention can use a form of a computer program product that is implemented on one or more computer-usable storage media (including but not limited to a disk memory, a CD-ROM, an optical memory, etc.) that include computer-usable program code.

The present invention is described with reference to the flowcharts and/or block diagrams of the method, the device (system), and the computer program product based on the implementations of the present invention. It should be understood that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, a built-in processor, or a processor of any other programmable data processing device to generate a machine, so that the instructions executed by the computer or the processor of the other programmable data processing device generate an apparatus for implementing a specific function in one or more processes in the flowcharts and/or in one or more blocks in the block diagrams.

These computer program instructions can be stored in a computer readable memory that can instruct the computer or any other programmable data processing device to work in a specific method, so that the instructions stored in the computer readable memory generate an artifact that includes an instruction apparatus. The instruction apparatus implements a specific function in one or more processes in the flowcharts and/or in one or more blocks in the block diagrams.

These computer program instructions can be loaded to a computer or another programmable data processing device so that a series of operations and steps are performed on the computer or the other programmable device, thereby generating computer-implemented processing. Therefore, the instructions executed on the computer or the other programmable device provide steps for implementing a specific function in one or more processes in the flowcharts and/or in one or more blocks in the block diagrams.

In a typical configuration, the computing device includes one or more processors (CPU), one or more input/output interfaces, one or more network interfaces, and one or more memories.

The memory can include a non-persistent memory, a random access memory (RAM), a nonvolatile memory, and/or another form that are in a computer readable medium, for example, a read-only memory (ROM) or a flash memory (flash RAM). The memory is an example of the computer readable medium.

The computer readable medium includes persistent, non-persistent, movable, and unmovable media that can implement information storage by using any method or technology. Information can be a computer readable instruction, a data structure, a program module, or other data. A computer storage medium includes but is not limited to a parameter random access memory (PRAM), a static random access memory (SRAM), a dynamic random access memory (DRAM) or another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a magnetic tape/magnetic disk memory or another magnetic storage device, or any other non-transmission media that can be used to store information that can be accessed by the computing device. Based on the definition in the present specification, the computer readable medium does not include transitory computer readable medium (transitory media), for example, a modulated data signal and carrier.

It is worthwhile to further note that the term “include”, “contain”, or their any other variant is intended to cover a non-exclusive inclusion, so that a process, a method, merchandise, or a device that includes a list of elements not only includes those elements but also includes other elements that are not expressly listed, or further includes elements inherent to such process, method, merchandise, or device. Without more constraints, an element preceded by “includes a . . . ” does not preclude the existence of additional identical elements in the process, method, merchandise, or device that includes the element.

A person skilled in the art should understand that the implementations of the present application can be provided as a method, a system, or a computer program product. Therefore, the present application can use a form of hardware only implementations, software only implementations, or implementations with a combination of software and hardware. In addition, the present application can use a form of a computer program product that is implemented on one or more computer-usable storage media (including but not limited to a disk memory, a CD-ROM, an optical memory, etc.) that include computer-usable program code.

The present application can be described in the general context of computer executable instructions executed by a computer, for example, a program module. Generally, the program module includes a routine, a program, an object, a component, a data structure, etc. for executing a specific task or implementing a specific abstract data type. The present application can also be practiced in distributed computing environments. In the distributed computing environments, tasks are performed by remote processing devices connected through a communications network. In a distributed computing environment, the program module can be located in both local and remote computer storage media including storage devices.

The implementations in the present specification are all described in a progressive way. For the same or similar parts of the implementations, references can be made to the implementations. Each implementation focuses on a difference from other implementations. Particularly, a system implementation is basically similar to a method implementation, and therefore is described briefly. For related parts, references can be made to partial descriptions of the method implementation.

The previous descriptions are merely implementations of the present application, and are not intended to limit the present application. A person skilled in the art can make various modifications and changes to the present application. Any modification, equivalent replacement, improvement, etc. made within the spirit and principle of the present application shall fall within the scope of the claims of the present application.

Embodiments and the operations described in this specification can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including by way of example a programmable processor, a computer, a system on a chip, or multiple ones, or combinations, of the foregoing. The apparatus can include special purpose logic circuitry, for example, a central processing unit (CPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example an operating system or a combination of operating systems), a cross-platform runtime environment, a virtual machine, or a combination of one or more of them. The apparatus and execution environment can realize various different computing model infrastructures, such as web services, distributed computing and grid computing infrastructures.

A computer program (also known, for example, as a program, software, software application, software module, software unit, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be executed on one computer or on multiple computers that are located at one site or distributed across multiple sites and interconnected by a communication network.

Processors for execution of a computer program include, by way of example, both general- and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data. A computer can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry.

Mobile devices can include handsets, user equipment (UE), mobile telephones (for example, smartphones), tablets, wearable devices (for example, smart watches and smart eyeglasses), implanted devices within the human body (for example, biosensors, cochlear implants), or other types of mobile devices. The mobile devices can communicate wirelessly (for example, using radio frequency (RF) signals) to various communication networks (described below). The mobile devices can include sensors for determining characteristics of the mobile device's current environment. The sensors can include cameras, microphones, proximity sensors, GPS sensors, motion sensors, accelerometers, ambient light sensors, moisture sensors, gyroscopes, compasses, barometers, fingerprint sensors, facial recognition systems, RF sensors (for example, Wi-Fi and cellular radios), thermal sensors, or other types of sensors. For example, the cameras can include a forward- or rear-facing camera with movable or fixed lenses, a flash, an image sensor, and an image processor. The camera can be a megapixel camera capable of capturing details for facial and/or iris recognition. The camera along with a data processor and authentication information stored in memory or accessed remotely can form a facial recognition system. The facial recognition system or one-or-more sensors, for example, microphones, motion sensors, accelerometers, GPS sensors, or RF sensors, can be used for user authentication.

To provide for interaction with a user, embodiments can be implemented on a computer having a display device and an input device, for example, a liquid crystal display (LCD) or organic light-emitting diode (OLED)/virtual-reality (VR)/augmented-reality (AR) display for displaying information to the user and a touchscreen, keyboard, and a pointing device by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments can be implemented using computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with a server, or through a server, for example, performing buy, sell, pay, give, send, or loan transactions, or authorizing the same. Such transactions may be in real time such that an action and a response are temporally proximate; for example an individual perceives the action and the response occurring substantially simultaneously, the time difference for a response following the individual's action is less than 1 millisecond (ms) or less than 1 second (s), or the response is without intentional delay taking into account processing limitations of the system.

Examples of communication networks include a local area network (LAN), a radio access network (RAN), a metropolitan area network (MAN), and a wide area network (WAN). The communication network can include all or a portion of the Internet, another communication network, or a combination of communication networks. Information can be transmitted on the communication network according to various protocols and standards, including Long Term Evolution (LTE), 5G, IEEE 802, Internet Protocol (IP), or other protocols or combinations of protocols. The communication network can transmit voice, video, biometric, or authentication data, or other information between the connected computing devices.

Features described as separate implementations may be implemented, in combination, in a single implementation, while features described as a single implementation may be implemented in multiple implementations, separately, or in any suitable sub-combination. Operations described and claimed in a particular order should not be understood as requiring that the particular order, nor that all illustrated operations must be performed (some operations can be optional). As appropriate, multitasking or parallel-processing (or a combination of multitasking and parallel-processing) can be performed.

What is claimed is:

1. A computer-implemented method for resource transmission, comprising:
receiving, by a server, a resource sending request of a first user, wherein the resource sending request comprises at least one of a resource to be sent, a user question matching the resource, or location information corresponding to the resource;
releasing, by the server, the location information to verify a second user based on the user question when the second user obtains the resource through a search based on the released location information; and
sending, by the server, the resource to the second user in response to determining that the verification succeeds.

2. The computer-implemented method of claim 1, wherein, before the receiving a resource sending request of a first user, the method further comprises:
receiving a redemption information acquisition request sent by the first user;
generating resource redemption information based on the redemption information acquisition request;
feeding back the resource redemption information to the first user; and
wherein the receiving a resource sending request of a first user comprises:
receiving the resource sending request that is sent by the first user and that uses the resource redemption information as a resource, wherein the resource redemption information comprises at least a merchandise redemption code.

3. The computer-implemented method of claim 2, wherein, before the receiving a redemption information acquisition request sent by the first user, the method further comprises:
receiving information about a transaction between the first user and an offline merchant providing a resource redemption service;
initiating a resource sending query to the first user;
wherein the receiving a redemption information acquisition request sent by the first user comprises:
receiving a merchandise redemption code request sent by the first user based on the resource sending query; and
wherein the generating resource redemption information and feeding back the resource redemption information to the first user comprises:
determining user information of the first user and user information of the offline merchant based on the transaction information;
generating a resource redemption code corresponding to the user information of the first user and the user information of the offline merchant; and
feeding back the resource redemption code to the first user and the offline merchant.

4. The computer-implemented method of claim 2, wherein the receiving a redemption information acquisition request sent by the first user comprises:
receiving a merchandise redemption code request that is sent by the first user and that comprises user information of the first user and user information of an offline merchant providing a resource redemption service.

5. The computer-implemented method of claim 1, further comprising:
detecting whether a second user triggers a question verification condition of a sent resource;
sending a user question corresponding to the sent resource to the second user in response to detecting that the second user triggers the question verification condition, wherein the second user feeds back an answer to be verified based on the user question;
receiving and verifying the answer to be verified that is fed back by the second user; and
sending the resource to the second user in response to determining that the verification succeeds.

6. The computer-implemented method of claim 5, wherein detecting whether a second user triggers a question verification condition of a sent resource comprises:
detecting and receiving a resource acquisition request sent by the second user for the sent resource; or
detecting that a location of the second user is within a specified range of a location of the sent resource.

7. The computer-implemented method of claim 5, further comprising:
determining user information of the second user sending a resource acquisition request;
counting a quantity of resource acquisition requests sent by the second user or a quantity of verification times based on the user information; and
feeding back predetermined overrun prompt information to the second user in response to determining that the quantity of resource acquisition requests or the quantity of verification times exceeds a specified quantity.

8. The computer-implemented method of claim 1, further comprising:
receiving resource redemption information sent by a second user;
verifying, based on stored resource redemption information, the resource redemption information sent by the second user, wherein the stored resource redemption information is generated and sent by a server after information about a transaction with a first user is sent to the server; and
providing a resource corresponding to the resource redemption information for the second user after the verification succeeds.

9. A non-transitory computer-readable medium storing one or more instructions executable by a computer system to perform operations comprising:
receiving a resource sending request of a first user, wherein the resource sending request comprises at least one of a resource to be sent, a user question matching the resource, or location information corresponding to the resource;
releasing the location information to verify a second user based on the user question when the second user obtains the resource through a search based on the released location information; and
sending the resource to the second user in response to determining that the verification succeeds.

10. The non-transitory computer-readable medium of claim 9, wherein, before the receiving a resource sending request of a first user, the operations further comprise:
receiving a redemption information acquisition request sent by the first user;
generating resource redemption information based on the redemption information acquisition request;
feeding back the resource redemption information to the first user; and
wherein the receiving a resource sending request of a first user comprises:
receiving the resource sending request that is sent by the first user and that uses the resource redemption information as a resource, wherein the resource redemption information comprises at least a merchandise redemption code.

11. The non-transitory computer-readable medium of claim 10, wherein, before the receiving a redemption information acquisition request sent by the first user, the operations further comprise:
receiving information about a transaction between the first user and an offline merchant providing a resource redemption service;
initiating a resource sending query to the first user;
wherein the receiving a redemption information acquisition request sent by the first user comprises:
receiving a merchandise redemption code request sent by the first user based on the resource sending query; and
wherein the generating resource redemption information and feeding back the resource redemption information to the first user comprises:
determining user information of the first user and user information of the offline merchant based on the transaction information;
generating a resource redemption code corresponding to the user information of the first user and the user information of the offline merchant; and
feeding back the resource redemption code to the first user and the offline merchant.

12. The non-transitory computer-readable medium of claim 10, wherein the receiving a redemption information acquisition request sent by the first user comprises:
receiving a merchandise redemption code request that is sent by the first user and that comprises user information of the first user and user information of an offline merchant providing a resource redemption service.

13. The non-transitory computer-readable medium of claim 9, wherein the operations further comprise:
detecting whether a second user triggers a question verification condition of a sent resource;
sending a user question corresponding to the sent resource to the second user in response to detecting that the second user triggers the question verification condition, wherein the second user feeds back an answer to be verified based on the user question;
receiving and verifying the answer to be verified that is fed back by the second user; and
sending the resource to the second user in response to determining that the verification succeeds.

14. The non-transitory computer-readable medium of claim 13, wherein detecting whether a second user triggers a question verification condition of a sent resource comprises:
detecting and receiving a resource acquisition request sent by the second user for the sent resource; or
detecting that a location of the second user is within a specified range of a location of the sent resource.

15. The non-transitory computer-readable medium of claim 13, wherein the operations further comprise:
determining user information of the second user sending a resource acquisition request;
counting a quantity of resource acquisition requests sent by the second user or a quantity of verification times based on the user information; and
feeding back predetermined overrun prompt information to the second user in response to determining that the quantity of resource acquisition requests or the quantity of verification times exceeds a specified quantity

16. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a resource sending request of a first user, wherein the resource sending request comprises at least one of a resource to be sent, a user question matching the resource, or location information corresponding to the resource;
releasing the location information to verify a second user based on the user question when the second user obtains the resource through a search based on the released location information; and
sending the resource to the second user in response to determining that the verification succeeds.

17. The computer-implemented system of claim 16, wherein, before the receiving a resource sending request of a first user, the operations further comprise:
receiving a redemption information acquisition request sent by the first user;
generating resource redemption information based on the redemption information acquisition request;
feeding back the resource redemption information to the first user; and
wherein the receiving a resource sending request of a first user comprises:
receiving the resource sending request that is sent by the first user and that uses the resource redemption information as a resource, wherein the resource redemption information comprises at least a merchandise redemption code.

18. The computer-implemented system of claim 17, wherein, before the receiving a redemption information acquisition request sent by the first user, the operations further comprise:
receiving information about a transaction between the first user and an offline merchant providing a resource redemption service;
initiating a resource sending query to the first user;
wherein the receiving a redemption information acquisition request sent by the first user comprises:
receiving a merchandise redemption code request sent by the first user based on the resource sending query; and
wherein the generating resource redemption information and feeding back the resource redemption information to the first user comprises:
determining user information of the first user and user information of the offline merchant based on the transaction information;
generating a resource redemption code corresponding to the user information of the first user and the user information of the offline merchant; and
feeding back the resource redemption code to the first user and the offline merchant.

19. The computer-implemented system of claim 17, wherein the receiving a redemption information acquisition request sent by the first user comprises:
receiving a merchandise redemption code request that is sent by the first user and that comprises user information of the first user and user information of an offline merchant providing a resource redemption service.

20. The computer-implemented system of claim 16, wherein the operations further comprise:
detecting whether a second user triggers a question verification condition of a sent resource;
sending a user question corresponding to the sent resource to the second user in response to detecting that the second user triggers the question verification condition, wherein the second user feeds back an answer to be verified based on the user question;
receiving and verifying the answer to be verified that is fed back by the second user; and
sending the resource to the second user in response to determining that the verification succeeds.
